(19) United States
(12) Patent Application Publication
(10) Pub. No.: US 2006/0192657 A1
(43) Pub. Date: Aug. 31, 2006

(54) Electronic apparatus

(75) Inventors: Hideki Nishimura, Kawasaki-shi (JP); Syunichi Yamashita, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignee: NEC INFRONTIA CORPORATION

(21) Appl. No.: 11/353,104

(22) Filed: Feb. 14, 2006

(30) Foreign Application Priority Data
Feb. 15, 2005 (JP) 2005-37765

(51) Int. Cl. G08B 6/00; G09B 21/00; G09G 5/00

(52) U.S. Cl. 340/407.2; 434/112; 345/173

(57) ABSTRACT

In an electronic apparatus having a touch panel, four fixing cushions are fixed at four corners of a rear surface of the touch panel. The fixing cushions are further fixed to a fixing frame to support the touch panel against to the fixing frame. Pair of vibrating elements are fixed to the rear surface of the touch panel along edges, which are parallel to each other, of the touch panel. The vibrating elements elastically bend the touch panel to cause flexural vibration to the touch panel. The fixing cushions have softness to allow the touch panel to vibrate and hardness to serve as fulcrums of the flexural vibration of the touch panel.

This application claims priority to prior application JP 2005-037765, the disclosure of which is incorporated herein by reference.

### BACKGROUND OF THE INVENTION

This invention relates to an electronic apparatus, particularly, to improvement of an electronic apparatus which is configured so that a flat vibrating body (e.g. a touch panel) is vibrated by a vibrating element(s).

A touch panel is well known as an input device for an electronic apparatus. A type of the touch panel provides a vibrating function to give operation feeling to an operator.

The touch panel having the vibrating function vibrates when its surface is pressed with a finger of the operator, a stylus held by the operator, or the like. The vibration of the touch panel is transmitted to the operator through the finger or the like. Thus, the operator perceives whether input operation executed by the operator is accepted by the electronic apparatus or not.

A conventional electric apparatus of this type includes a movable board, a supporting substrate, an adhesive layer, and a piezoelectric board. The movable board and the supporting substrate are located parallel to each other. The adhesive layer is disposed between the movable board and the supporting substrate along edges of them to leave a space between them. The piezoelectric board having driving electrodes formed on both surfaces thereof is fixed to the movable board or the supporting substrate along one of the edges of the movable board or the supporting substrate. With this structure, the movable board vibrates according to vibration of the piezoelectric board.

Such an electric apparatus is disclosed in Unexamined Japanese Patent Publication No. P2003-122507A.

Another conventional electronic apparatus has a touch panel, a supporting frame, supporting members and four piezoelectric actuators. The touch panel and the supporting frame are disposed parallel to each other. The supporting members fix the touch panel to the supporting frame to leave a space between them. The piezoelectric actuators are disposed between the touch panel and the supporting frame and fixed to the supporting frame at vicinities of four corners of the supporting frame. When the piezoelectric actuators are driven, they tap at (or vibrate) the touch panel. In other words, the touch panel vibrates according to vibration of the piezoelectric actuators.

Such an electronic apparatus is disclosed in Unexamined Japanese Patent Publication No. P2004-94389A.

In the former conventional electronic apparatus, the movable board is fixed to the supporting substrate with the adhesive layer. Accordingly, the piezoelectric board vibrates both of the movable board and the supporting substrate whether it is fixed to the mobile board or the supporting substrate. Therefore, the conventional apparatus has a problem of small vibrating amplitude of the touch panel. The vibrating amplitude of the touch panel depends on fixing condition of the supporting substrate.

In the latter conventional electronic apparatus, the touch panel reciprocates small along a direction perpendicular to a main surface thereof. Accordingly, it is necessary that the supporting members have suppleness to hardly avoid the touch panel from reciprocating. Accordingly, the conventional electronic apparatus has a problem that the supporting members unsteadily support the touch panel.

### SUMMARY OF THE INVENTION

It is therefore an object of this invention to provide an electrical apparatus having a flat vibrating board (e.g. a touch panel) which can vibrate greatly under condition that the flat vibrating board is stably supported.

Other objects of this invention will become clear as the description proceeds.

According to an aspect of this invention, an electronic apparatus includes a flat vibrating body and a vibrating element(s). The vibrating element(s) elastically bends the flat vibrating body to cause flexural vibration to the flat vibrating body. Four fixing cushions are fixed on a surface of the flat vibrating body to be placed at four corners of an imaginary rectangle. The four fixing cushions support the flat vibrating body to allow the flexural vibration.

The flat vibrating body may have a rectangular shape. In this case, the fixing cushions may be fixed at four corners of the surface of the flat vibrating body.

The fixing cushions may be disposed to serve as fulcrums of the flexural vibration.

The vibrating element may be disposed along an edge of the flat vibrating body. An additional vibrating element may be disposed to be parallel with the vibrating element along another edge of the flat vibrating body.

The vibrating element may be fixed to the surface of the flat vibrating body.

The electronic apparatus may have a fixing frame. The fixing cushions are fixed to the fixing frame and thereby the flat vibrating body is attached to the fixing frame.

The vibrating element may be out of touch with the fixing frame.

The flat vibrating body may be a touch panel.

The fixing frame may be a liquid crystal display panel.

### BRIEF DESCRIPTION OF THE DRAWINGS

FIG. 1 is a perspective view of an electronic apparatus according to a first embodiment of this invention;

FIG. 2 is an exploded perspective view of the electronic apparatus of FIG. 1;

FIG. 3 is a schematic diagram for describing a vibrating state of a touch panel included in the electronic apparatus of FIG. 1;

FIG. 4A is a schematic plane view showing a variation of the electronic apparatus of the first embodiment;

FIG. 4B is a schematic side view of the electronic apparatus of FIG. 4A;

FIG. 5 is a perspective view of an electronic apparatus according to a second embodiment of this invention;

FIG. 6 is an exploded perspective view of a display and touch panel portion included in the electronic apparatus of FIG. 5;

FIG. 7 is a partly sectional view taken along a line VII-VII of FIG. 5; and

FIG. 8 is an exploded perspective view of an electronic apparatus according to a third embodiment of this invention.

### DESCRIPTION OF THE PREFERRED EMBODIMENTS

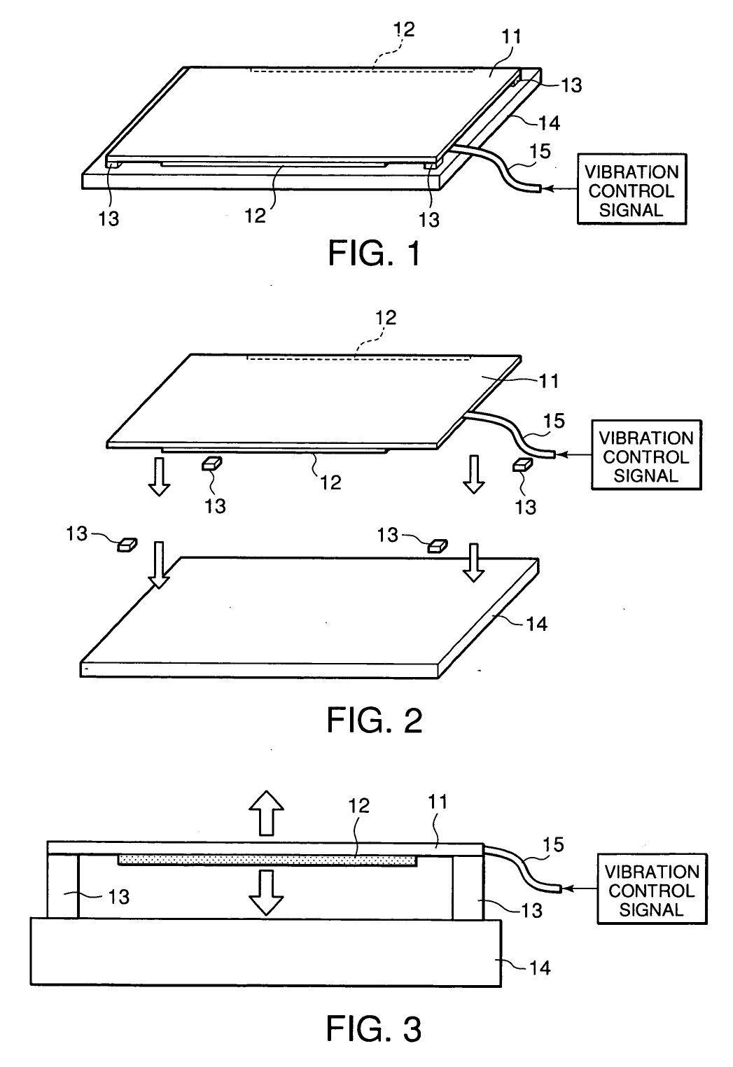

Referring to FIGS. 1 to 3, a description will be directed to an electronic apparatus according to a first embodiment of this invention.

FIG. 1 is a perspective view of the electronic apparatus (or a panel assembly) of the first embodiment while FIG. 2 is an exploded perspective view thereof.

The electronic apparatus includes a rectangular touch panel (or a flat vibrating body) 11 having a glass or resinous substrate at a rear side thereof. On a rear surface of the touch panel 11, pair of vibrating elements 12 are fixed along upper (or rear side of FIG. 2) and lower (or front side of FIG. 2) edges of the touch panel 11. The rear surface of the touch panel 11 corresponds to an exposed surface of the glass or resinous substrate. Further, on the rear surface of the touch panel 11, four fixing cushions 13 are fixed at (vicinities of) four corners of the touch panel 11. A fixing frame 14 has a frame or rectangular shape, which is nearly equal to or slightly larger than the touch panel 11 in length and breadth, to support the touch panel 11 through the fixing cushions 13.

The touch panel 11 is configured like a known touch panel.

The vibrating elements 12 are piezoelectric elements, actuators, or the like, and are connected to a vibration control signal line 15. The vibrating elements 12 are out of touch with the fixing frame 14. The vibrating elements 12 are expanded and contracted by a vibration control signal (or a driving voltage) supplied from an external controller (not shown) through the vibration control signal line 15. Expansion and contraction of the vibrating elements 12 elastically bend the touch panel 11 and cause flexural vibration to the touch panel 11. The flexural vibration of the touch panel 11 makes it possible to obtain a simple structure and large vibration amplitude in comparison with the conventional electronic apparatus that the touch panel reciprocates to vibrate.

Each of the fixing cushions 13 has an approximately cubic shape. The fixing cushions 13 are placed at four corners of an imaginary rectangle on the rear surface of the touch panel 11. The fixing cushions 13 are out of touch with the vibrating elements 12. The imaginary rectangle has two pairs of sides. One of the pair of sides is parallel to the vibrating elements 12 while the other pair is perpendicular to the vibrating elements 12. In this embodiment, the imaginary rectangle corresponds to rear surface of the touch panel 11. Accordingly, the fixing cushions 13 are fixed at (vicinities of) the four corners of the rear surface of the touch panel 11 with double faced adhesive tapes, adhesive material, or the like. The fixing cushions 13 attach the touch panel 11 to the fixing frame 14 and serve as fulcrums (or nodes) in case where the flexural vibration is caused to the touch panel 11. The fixing cushions 13 have a thickness to leave a space for flexural (or bending) vibration of the touch panel 11 between the touch panel 11 and fixing frame 14. That is, the fixing cushions 13 are larger than the vibrating elements 12 in thickness. The fixing cushions 13 are made of relatively hard material (having 40 degrees of hardness, for example) so as not to damp (or absorb) the vibration of the touch panel 11. Because the relatively hard material is used for the touch panel 11, the touch panel 11 is stably fixed to and supported by the fixing frame 14. Furthermore, because the fixing cushions 13 supports at both sides of the vibrating elements 12 in the longitudinal direction, the touch panel 11 can vibrate effectively and greatly. In addition, because the touch panel 11 is supported at the corners, edges thereof are as free ends and the vibration of the touch panel 11 is hard to be limited.

The fixing frame 14 is a liquid crystal display panel, for example, and has hardness so as not to be deformed by the flexural vibration of the touch panel 11. The fixing cushions 13 fixed to the touch panel 11 are fixed on a front surface of the fixing frame 14 by double faced adhesive tapes, adhesive material, or the like.

FIG. 3 shows a vibrating state of the touch panel 11. Upon supplying the vibration control signal (or AC voltage) to the vibration control signal line 17, the vibrating elements 12 are expanded and contracted in a lateral direction of FIG. 3 according to the vibration control signal. Because the touch panel 11 is supported by the fixing cushions 13 at the both sides of the vibrating elements 12, the expansion and contraction of the vibrating elements 12 in the lateral direction bend the touch panel 11 elastically in an upward and downward direction as depicted by outline arrows in FIG. 3. Thus, the touch panel 11 vibrates like a beam which both ends thereof are fixed. That is, the flexural vibration is caused to the touch panel 11.

When the fixing cushions 13 are too hard, it is difficult for the touch panel 11 to vibrate. To the contrary, when the fixing cushions 13 are too soft, it absorbs the vibration of the touch panel 11. Therefore, the fixing cushions 13 need softness to allow the vibration of the touch panel 11 and hardness to hardly absorb the vibration of the touch panel 11. The fixing cushions 13 are made of material selected to meet the requirements mentioned above. It is preferable that high density micro cell polyurethane foam is used as the material of the fixing cushions 13. In particular, PORON HH-48 with 40-50 degrees of hardness or PORON H-48 with 40 degrees of hardness is more preferable as the material for the fixing cushions 13. The PORON is a brand name owned by ROGERS INOAC CORPORATION.

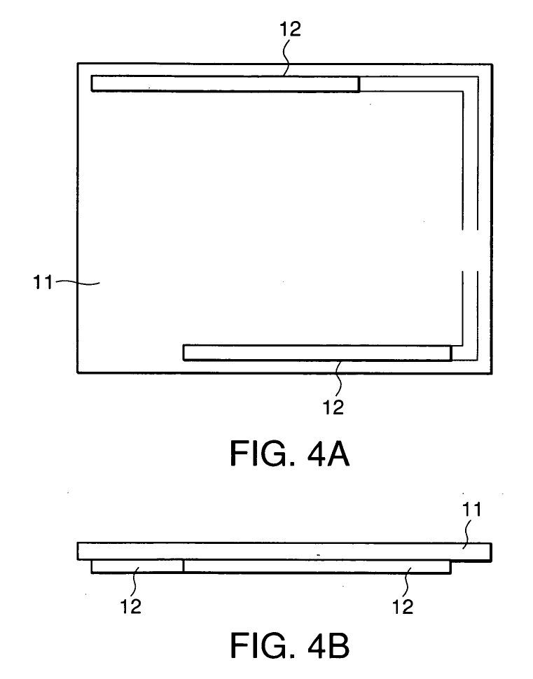

As mentioned above, in this embodiment, the vibrating elements 12 are provided along the upper and the lower edges which are long sides of the touch panel 11. However, the vibrating elements 12 may be provided along the right and the left edges which are short sides of the touch panel 11. Furthermore, it is unnecessary that the vibrating elements 12 stretch from one ends of the upper and the lower (or the right and the left) edges to the other ends of the touch panel 11. The vibrating elements 12 may be provided as illustrated in FIGS. 4A and 4B. That is, one of the vibrating elements 12 may be provided at the right hand side of the upper/lower edge while the other may be provided at the left hand side of the lower/upper edge. In addition, the number of the vibrating elements 12 is not limited to two. The number may be decided on one or more according to the size and/or the shape of the touch panel (or the flat vibrating body) 11.

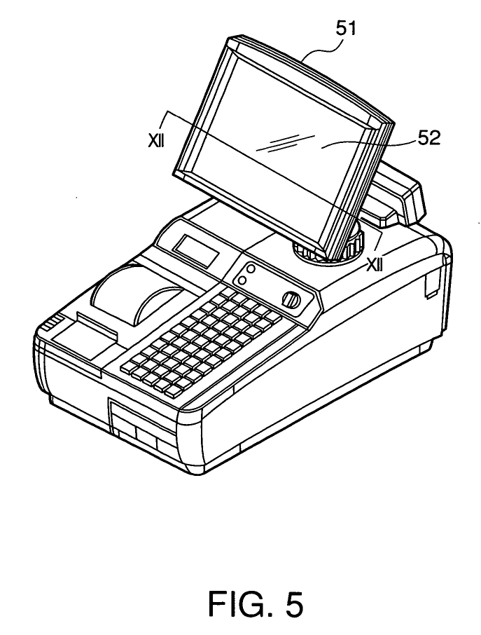

Next, referring to FIGS. 5 to 7, the description will be made about an electronic apparatus (i.e. a POS terminal) according to a second embodiment of this invention.

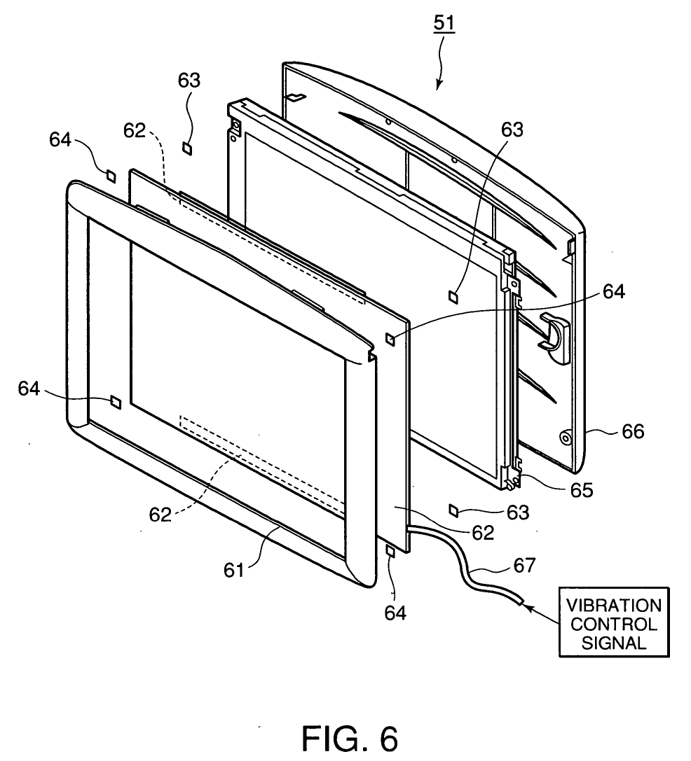

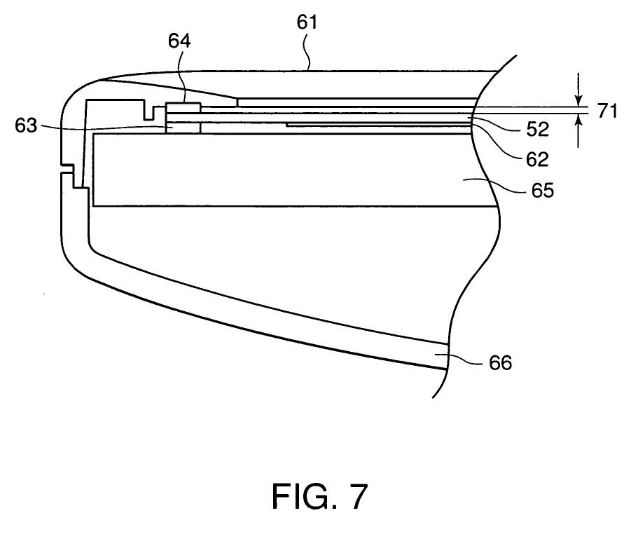

The electronic apparatus of FIG. 5 has a display and touch panel portion 51. The display and touch panel portion 51 includes a touch panel 52 with a vibrating function. FIG. 6 is an exploded perspective view of the display and touch panel portion 51. FIG. 7 is a partly sectional view of the display and touch panel portion 51.

The display and touch panel portion 51 serves as a display unit for displaying information and as an input unit for receiving input data. The display and touch panel portion 51 includes a front bezel 61, vibrating elements 62, fixing cushions 63, pressing cushions 64, a liquid crystal display panel (LCD) 65, and a rear cover 66, in addition to the touch panel 52. A combination of the touch panel 52, the vibrating elements 62, the fixing cushions 63, and the LCD 65 corresponds to the panel assembly of FIG. 1. The front bezel 61 and the rear cover 66 form a housing for housing the touch panel 52, the LCD 65, and so on.

The touch panel 52 is similar to a known touch panel and configured to detect coordinates representing a pressed position on a surface thereof. Furthermore, the touch panel 52 is formed by the use of transparent substrate, transparent electrodes, transparent insulating films, and so on, so that display of the LCD 65 can be seen through the touch panel 52.

The vibrating elements 62 are unimorph type piezoelectric elements, for example. To provide a vibrating function to the touch panel 52, the vibrating elements 62 are fixed to a glass (or resinous) substrate of the touch panel 52 along upper and lower edges of the touch panel 52. The surface of the glass substrate corresponds to the rear surface of the touch panel 52. The number of the vibrating elements 62 is not limited to two and may be at least one. At any late, one or more vibrating elements may be fixed to the touch panel 52 along the upper edge and/or the lower edge of the touch panel 52. The vibrating elements 62 are connected to a vibration control signal line 67. The vibrating elements 62 are expanded and contracted by supplying a vibration control signal (or AC voltage) through the vibration control signal line 67 and flexural vibration is caused to the touch panel 52.

The fixing cushions 63 are made of PORON HH-48 (the brand name), for example. The fixing cushions 63 are placed at four corners of an imaginary rectangle on the rear surface of the touch panel 52. The imaginary rectangle has two pairs of sides. One of the pair of sides is parallel to the vibrating elements 62 while the other pair is perpendicular to the vibrating elements 62. In this embodiment, the imaginary rectangle corresponds to rear surface of the touch panel 52. Accordingly, the fixing cushions 63 are fixed at (vicinities of) the four corners of the rear surface of the touch panel 52 with double faced adhesive tapes, adhesive material, or the like. The fixing cushions 63 are further fixed to the front surface of the LCD 65 and thereby the touch panel 52 is attached to the LCD 65. In other words, the LCD 65 supports the touch panel 52 through the fixing cushions 63. The fixing cushions 63 serve as fulcrums when the flexural vibration of the touch panel 52 is caused. As mentioned regarding the first embodiment, it is desirable that the fixing cushions 63 are made of material which allows the touch panel to vibrate and which can avoid damping the vibration of the touch panel 52 as possible and which is neither too soft nor too hard. For example, the material may have about 40 degrees of hardness. When the fixing cushions 63 are too hard, it is difficult for the touch panel 52 to vibrate. To the contrary, when the fixing cushions 63 are too soft, it absorbs the vibration of the touch panel 52 to reduce amplitude of the vibration.

As shown in FIG. 7, the pressing cushions 64 are disposed between the front bezel 61 and the touch panel 52 to make an interval 71 between them. The pressing cushions 64 are designed so as not to prevent and absorb the vibration of the touch panel 52. Furthermore, the pressing cushions 64 are designed so that the touch panel 52 does not touch (or tap) the front bezel 61 during the vibration thereof. To meet these conditions, material and size of the pressing cushions 64 are appropriately selected and decided. In this embodiment, the pressing cushions 64 made of soft urethane form, e.g. POLON L32 (the brand mane), are disposed on the front surface of the touch panel 52 to correspond the fixing cushions 63. In other words, the pressing cushions 64 and the fixing cushions 63 make pairs to sandwich the touch panel between them. Because the pressing cushions 64 correspond to the fixing cushions 63, the touch panel 52 is further securely and stably held without preventing and absorbing the vibration thereof.

The LCD 65 has a known configuration and is fixed to the rear cover 66 by means of, for example, screws.

In the structure mentioned above, upon supplying the vibration control signal to the vibrating elements 62 through the vibration control signal line 69, the touch panel 52 on which the vibrating elements 62 is fixed vibrates according to wave form of the vibration control signal. In this event, the fixing cushions 63 fixed to the touch panel 52 serve as fulcrums for the vibration of the touch panel 52. The fixing cushions 63 hardly absorb the vibration of the touch panel 52. The edges of the touch panel are as free ends and the vibration of the touch panel 52 is hard to be limited. Thus, the large vibration amplitude of the touch panel 52 is obtained in this embodiment.

According to the embodiment, the electronic apparatus vibrates the touch panel 52 when an operator executes input operation to the touch panel 52. Consequently, operation feeling is given to the operator by the touch panel 52.

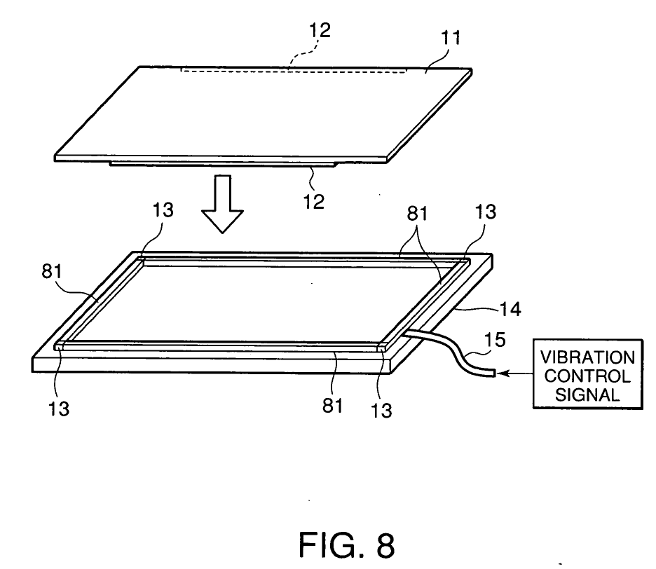

Next, the description will be made about still another electronic apparatus (e.g. a panel assembly) according to a third embodiment of this invention with reference to FIG. 8.

The electronic apparatus of this embodiment is similar to that of the first embodiment except for providing dustproof cushions 81.

As shown in FIG. 8, the providing dustproof cushions 81 disposed between the touch panel 11 and the fixing frame (e.g. LCD) 14 to from a rectangle having vertexes corresponding to the fixing cushions 13. In other words, each of the providing dustproof cushions 81 connects adjacent two of the fixing cushions 13. The dustproof cushions 81 are fixed to the touch panel 11 and the fixing frame 14 by double faced adhesive tapes, adhesive material, or the like, similarly as for the fixing cushions 13. The dustproof cushions 81, as understood from the name, prevent dust from coming in the space between the touch panel 11 and the fixing frame 14. The dustproof cushions 81 are made of material which is very soft in comparison with that of the fixing cushions 13 so as not to prevent and absorb the vibration of the touch panel 11.

In the electronic apparatus of this embodiment, the touch panel 11 is securely and stably fixed to the fixing frames 14 and allowed to vibrate greatly.

While this invention has thus far been described in conjunction with the preferred embodiments thereof, it will readily be possible for those skilled in the art to put this invention into practice in various other manners. For example, the electronic apparatus may be an automatic teller machine (ATM), a point of sale (POS) terminal, a personal computer (PC), a personal digital assistant (PDA), a mobile telephone, or the like. At any rate, this invention is applicable to the electronic apparatus including a touch panel or a vibrating board with vibrating function.

What is claimed is:

1. An electronic apparatus including a flat vibrating body, comprising:
a vibrating element for elastically bending said flat vibrating body to cause flexural vibration to said flat vibrating body; and
four fixing cushions fixed on a surface of said flat vibrating body to be placed at four corners of an imaginary rectangle;
wherein said four fixing cushions support said flat vibrating body to allow the flexural vibration.

2. An electronic apparatus as claimed in claim 1, wherein said flat vibrating body has a rectangular shape; and
wherein said fixing cushions are fixed at four corners of said surface of said flat vibrating body.

3. An electronic apparatus as claimed in claim 1, wherein said fixing cushions are disposed to serve as fulcrums for the flexural vibration.

4. An electronic apparatus as claimed in claim 1, wherein said vibrating element is disposed along an edge of said flat vibrating body.

5. An electronic apparatus as claimed in claim 4, further comprising additional vibrating element which is disposed to be parallel with said vibrating element along another edge of said flat vibrating body.

6. An electronic apparatus as claimed in claim 1, wherein said vibrating element is fixed to said surface of said flat vibrating body.

7. An electronic apparatus as claimed in claim 1, further comprising a fixing frame;
wherein said fixing cushions are fixed to said fixing frame and thereby said flat vibrating body is attached to said fixing frame.

8. An electronic apparatus as claimed in claim 7, wherein said vibrating element is out of touch with said fixing frame.

9. An electronic apparatus as claimed in claim 1, wherein said flat vibrating body comprises a touch panel.

10. An electronic apparatus as claimed in claim 7 wherein said fixing frame comprises a liquid crystal display panel.
